(19) United States
(12) Patent Application Publication
(10) Pub. No.: US 2016/0150774 A1
(43) Pub. Date: Jun. 2, 2016

(54) DEVICE FOR SEALING STAGNANT WATER TANKS

(71) Applicants: Thierry SUVIRI, Mont Dore (NC); Christophe PUT, Mont Dore (NC)

(72) Inventors: Thierry SUVIRI, Mont Dore (NC); Christophe PUT, Mont Dore (NC)

(21) Appl. No.: 14/901,383

(22) PCT Filed: Jun. 26, 2014
(86) PCT No.: PCT/FR2014/051620

§ 371 Date: Dec. 28, 2015

(30) Foreign Application Priority Data
Jun. 28, 2013 (FR) 1356285

(51) Int. Cl. A01M 99/00

(52) U.S. Cl. CPC A01M 99/00

(57) ABSTRACT

A device for combating the proliferation of aquatic larvae in containers likely to hold stagnant water, the containers (1) including a wall (2) defining a cavity (3) and an open hole (4), and including an element (10) whose shape is designed to completely or partially conform to that of the wall (2) of the cavity and to seal the hole, the element being produced from a porous material permeable to air and to water, including a rubber granulate and a synthetic binder. The device made from porous material occupies the opening of the tank which can therefore no longer be freely accessed by mosquitoes. A method implementing such a device is also described.

The present invention relates to the field of means for the prevention of insect-borne diseases and more particularly to that of devices and methods for reducing the proliferation of aquatic larvae, and mosquitoes in particular.

It relates to a device for combating the proliferation of aquatic larvae in the containers likely to retain stagnant water, whereby the insects no longer have access to these water tanks. The invention also relates to methods implementing such a device.

It is known that mosquitoes play an extremely important role in human or animal health as they represent, in addition to their role as nuisance biters, the largest group of vectors of pathogen agents transmissible to humans.

Mosquitoes are responsible for transmitting malaria, one of the leading causes of human mortality (every year, between 250 and 600 million people affected worldwide, and more than one million deaths), and numerous viral diseases such as dengue, yellow fever, Rift Valley fever, West Nile Virus, chikungunya, as well as various viral encephalitis and filariasis.

They are present in a variety of habitats throughout the planet's land surface (with the exception of Antarctica) as soon as a surface of fresh or brackish water, even small or temporary, is available. Sixty-five species are referenced in Metropolitan France and the number of departments affected by the tiger mosquito, a potential vector of several diseases, grows each year. In Oceania, and particularly in New Caledonia, mosquitoes are generally prevalent between December and April (even year round) and can transmit dengue, and more recently, chikungunya as well. In urban areas, the main vector is Aedes aegypti, a species attracted to man, and with mainly diurnal habits. Its habitual breeding sites are small artificial pools of water encountered around homes (flower pot saucers, pots for cuttings, vases, tires, gutters, etc.). Epidemics happen more or less frequently, as shown by the data published by the Pasteur Institute of New Caledonia.

Water is absolutely necessary for the development of the mosquito. Forty-eight hours after the blood meal, the fertilized females lay their eggs in water. These eggs develop in one to two days and give birth to aquatic larvae.

Breeding sites are highly diverse: permanent or temporary running or standing water, whether in a sunny (footpath) or shaded area (in the forest), large (lake, river) or small (dead leaf). Natural breeding sites can be formed by plants (leaf axils, hollow tree trunks, hollow mushrooms, fallen leaves, hollow fruit), and minerals (puddles, ruts, snail shells, rock holes). Artificial breeding sites include all locations forming a damp container: cisterns, drinking troughs, gutters, tires, junk automobiles, tarpaulins, cans, flower pots, etc.

Man has long sought to combat this scourge, which is a cause of itching and vector of diseases. There exist various large-scale control methods including the dispersal of products in highly infested areas or land use planning designed to limit breeding sites: drainage, wastewater collection, elimination of illegal dumps and open air storage facilities. Biological control methods can also be used to protect or restore populations of mosquito larvae predators such as frogs, toads, salamanders, swallows, bats, etc.

In urban areas, these methods are not always appropriate. The easiest way to avoid being invaded by mosquitoes is to eliminate, as much as possible, the potential reservoirs of stagnant water, even the smallest, where mosquitoes could lay eggs and larvae develop. Thus, health authorities recommend environmental monitoring near homes and the removal of containers likely to collect water (flower pots saucers, vases, cans, tarpaulins, gutters, open garbage cans, wheelbarrows, etc.).

However, recommended methods of combating the proliferation of breeding sites are restrictive on many levels. They have a limited effect over time and monitoring requires that actions be repeated regularly (at least with each new downpour): empty the flower pot saucers, ensure that the areas surrounding homes are cleaned, maintain the gardens, and turn over all recipients likely to retain water. Firstly, the loss of time ends up being dissuasive, and secondly, any absence of just a few days can negate an entire season's effort.

As far as the cleaning of gutters is concerned, practical difficulties create further constraints: accessibility, the need for a ladder, risk of falling, etc. In addition, occupants of homes who are unable to directly see the contents of the gutters have no incentive to clean them. The plant matter then clump together, creating pockets of stagnant water that are a paradise for larvae.

Finally, the pools of water that cannot be removed for practical reasons (pumping wells, etc.) must still be treated regularly with chemicals.

Finally, all the recommended methods are based either on larviciding or on the elimination of stagnant water points. The invention described below aims to solve the aforementioned problems by implementing a solution based on a different principle. It involves preventing female insects from accessing these reservoirs of stagnant water using a device designed to seal them off, without limiting the flow of water when it is necessary. This method thus permanently remedies the problem of Anopheles laying eggs in these tanks, and without the use of chemicals that may have an adverse impact on the environment.

To do this, a device made of a porous material was created, shaped to occupy the space of the reservoir which, thereby, is no longer freely accessible to mosquitoes. When it rains or water is discharged, the water enters the porosity of the material, without providing a suitable free surface for laying eggs. The water present in the porosity can then evaporate or flow by gravity. It can then remain in the bottom of the container, it being sealed by the porous device, or flow away if a drain is provided in the bottom of said reservoir. It is therefore apparent that this device can be used in many different scenarios where recessed areas are likely to form pools of stagnant water, whether they exist naturally or as a result of human activities.

It is also obvious that if mosquito control is the major concern, the device can be used to deny breeding sites to all types of insects and more generally to prevent other animals from using the water containers for their development.

More precisely, the invention concerns a device for combating the proliferation of aquatic larvae in containers likely to hold stagnant water, said containers comprising a wall defining a cavity and a large opening, this device comprising an element, the shape of which is designed to completely or partially conform to that of the wall of said cavity and to seal said opening, said element being produced from a material permeable to air and to water, comprising a rubber granulate and a synthetic binder.

The term ‘container’ refers to any zone having a recessed portion in which water can accumulate, even in small quantities, to constitute a breeding site. This container, whether natural or artificial (i.e. manufactured or built by man) includes a receiving portion holding the water, bounded by a wall, and an open portion through which water flows into the container, bounded by the upper edge of the wall of the container. As water flows by gravity, it is understood that the large opening is generally located in the upper part of the container, although at a more or less large distance below the upper edge of the container, in any case above the space where the water accumulates. It is further stated that as the containers capable of forming breeding sites are highly diverse in terms of their shape, dimensions and even texture, the aforementioned definitions shall be understood as relating to functions rather than to geometric structures in the strict sense. Similarly, it is understood that the term ‘water’ refers to any liquid effluent likely to serve as a stagnant breeding site, regardless of its precise composition and purity.

The device according to the invention is shaped to seal off access to the container. In doing so it can fill it completely or only partially, as discussed in detail below. It essentially (or only in some embodiments) comprises an element permeable to water and air. It does not act as a plug, but on the contrary as a filter. It thus allows the container to continue to play its role, particularly when the water must circulate. For example, rainwater can flow in gutters or through the catch basin of a pipe. It also allows air to pass, which is also important in balancing the pressures on either side of the element and to avoid decay phenomena.

Various materials can be used to produce the element. However, considering its purpose, certain requirements must be observed. The material must be rigid and able to adopt various shapes; it must be rot-proof and withstand climatic variations. Advantageously, in the device according to the invention, said material is an agglomerate with open porosity, consisting of elastomeric particles bonded with a polyurethane resin. However, other types of rigid or flexible granulates may be used, particularly aggregates obtained through polymer recycling processes. Examples include PVC granulates (polyvinyl chloride) obtained by recasting of containers, water bottles, or other.

An elastomer is a polymer having resilient properties, obtained after crosslinking. The term ‘rubber’ is a common synonym for elastomer. Elastomeric materials such as tires are often based on natural rubber and synthetic rubber. The rubber granulates used in the present invention are generally obtained by shredding used tires, making it a cheap raw material and helps contribute to waste recycling. The rubber particles are bound together with a binder, for forming a porous agglomerate. The rubber particles are sufficiently spaced and the binder is sufficiently minimally invasive, so that interstices or pores form between the particles. The structure and composition of the agglomerate are selected so that the pores form a network throughout the entire mass of the agglomerate, thereby creating an open porosity through the entire thickness of the porous element.

The binder is a synthetic compound that can be chosen from among many polymers available from manufacturers, based on defined specifications, and with regard to the specifications supplied by the manufacturers. For example, polyurethane can be used for the present invention. It is a well known polymer whose mechanical strength allows for relatively versatile use. It is the most commonly used polymer in the manufacture of foams and has numerous applications in the building construction and furniture sector, as well as in the automotive and nautical industries. Polyurethane foams are also widely used in the fabrication of sports flooring, where they can replace rubber granulates: they allow more or less high damping values to be achieved depending on their thickness.

According to the present invention, polyurethane is used as a binder to obtain a porous agglomerate, with open porosity. In this context the binder is preferably a polyurethane resin added to the rubber granulate at a ratio of 5% to 20% by weight relative to the rubber granulate. Preferably, it is added at a ratio of 15% in relation to the weight of rubber. The amount of binder is thus relatively low. It is chosen so as to obtain a network of open pores large enough to ensure that water flows rapidly through the material, while maintaining satisfactory cohesion of the agglomerate. For some applications, the high value of binder content can be used (or even exceeded) in order to increase the mechanical strength of the element, but at the expense of permeability. The choice of the agglomerate's binder content will thus be the result of an optimal compromise in the recommended range, which is adapted to the intended use of the present invention. In all cases, care should be taken to preserve total device permeability.

With the same objective, it will also be possible to adjust the size of the rubber particles. According to a preferred feature of the device of the present invention, the granulate is comprised of rubber particles ranging in size from 1 mm to several mm, e.g. up to 20 mm. The best granulate will be chosen based on the specific objectives sought and the priority given to each of them, firstly in terms of strength, durability, aging, rigidity, ease of implementation, and secondly in terms of permeability (the flow rate of water through the material is not always the first criterion, for flower pot applications, for example), while seeking to deny access to larvae.

Reference may be made to the Darcy coefficient of permeability (K) which expresses the flow of fluid filtering through a porous medium, by selecting its most favorable value for the invention as, in addition to the destruction of breeding sites, the present method must ensure the drainage of water. Experimental tests have shown that increasing the size of the granulates produced by shredding used tires (e.g. to a size of 8-12 mm) the K coefficient is twenty times higher than that of damping floor covering. Indeed, what is sought here is that the material absorbs and drains the largest quantity of fluid and denies access to mosquitoes, while the rubber+resin agglomerates intended for floor coverings must meet dampening standards, which is of no interest in the application covered by this invention. Advantageously, a granulate quality completely free of metal particles will be used.

The agglomerate is obtained by mixing the rubber granulate with the binder to obtain a malleable mixture, which sets in a few hours. It is therefore highly suitable for the production of elements according to the invention, having desired shapes. In particular, elements of predefined shape and dimensions may be made by molding. These preformed elements can then be placed in containers likely to constitute breeding sites. The rubber granulate and binder mixture may also be prepared extemporaneously, and placed in or on the potential breeding site where it will set on site.

Thus, in one embodiment of the device according to the invention, the porous element is preformed in a shape designed to completely conform to the wall of said cavity, so as to completely seal said container. This embodiment of the invention is suitable for example for flower pots placed on a saucer, which is designed to retain excess irrigation water. The space left between the pot and the saucer creates a suitable annular container for mosquitoes to lay eggs. In this case, a preformed annular element can be installed, adjusted to the dimensions of the pot and its saucer. When the plant is being watered (or during a downpour) the porosity of the element will absorb a quantity of water, which can then be reabsorbed by the plant through capillarity or simply evaporate, but the excess water will spill over and flow to the rainwater collection network depending on the slope of the ground. It should be noted that it is not imperative for the porous element to be exactly the same format as that of the pot and its saucer, the essential point being that no water surface is accessible to the Anopheles.

In another embodiment of the device according to the invention, the element is preformed in a shape designed to partially conform to the wall of said cavity, at least one through hole being provided in the lower part of the element so as to promote the circulation of the collected water after it has passed through said element. This embodiment is intended to allow water, which has passed through the porosity, to flow rapidly, which is particularly useful when liquid flows converge. This is notably the case for gutters fitted on the edge of roofs, or floor gutters. It is advantageous to have an element which is inserted between the side walls of the gutter, but which leaves a discharge channel free at its base. Conveniently, a block is used, extending longitudinally while matching the shape of the gutter, and whose lower part comprises a longitudinal groove. Several blocks are placed side by side successively to equip the entire length of the gutter. It should be noted that gutter accessories exist (such as grilles, netting, etc.) but which only permit the retention of plant matter, so they are of no use in combating breeding sites. Furthermore, they have a shorter service life.

Generally speaking, it is understood that the element of the device according to the invention may be formed in one piece or from several separate pieces which together form the element when installed. They can be preformed separately, or in a single block which is then cut into several pieces at the time of installation. It is then easier to insert the device into a cavity having a narrow opening. It is also easier to transport and install several pieces of moderate size, which will form a large protective device once assembled. Assembly may be achieved in any convenient way, by overlapping or juxtaposition. For rainwater catch basins in particular, it is possible to insert two overlapping parts into the opening, and then slide one on top of the other to expand the surface in order to seal off the catch basin.

In another embodiment of the device according to the invention, the element is preformed in a shape designed to partially conform to the wall of said cavity and able to cooperate with support means equipping the wall of the cavity so as to create a space at the bottom of the container for collecting the water after it has passed through said element. This embodiment is particularly suitable for downspout catch basins, domestic pipeline inspection chambers, or road drains. These are generally concrete tanks of rectangular cross-section, receiving water from above, and equipped with a discharge outlet near their base. Frequently, the bottom of these tanks is not regular, and also is at a lower level than the discharge outlet. Puddles of water are thus easily collected therein and remain. It is possible, according to the invention, to produce a block of the same rectangular cross section as the tank that it has to equip, which will be inserted into the tank until it abuts against a support member. The block can advantageously be equipped with a handle.

As indicated above, a porous element can alternatively be modelled on site. In this case, the granulate and binder mixture can be poured directly in the cavity of the container likely to attract mosquitoes. However, an embodiment preserving the removable nature of the porous element is preferred. This is why, according to the invention, it is proposed that the mixture be placed on a support grid. In this case, the grid (or lattice) can be raised, which promotes the rapid flow of water under the device. This grid also allows excess binder to drain, if any, when pouring the granulate and binder mixture, thus ensuring the formation of a perfectly permeable open porosity.

Thus, according to the invention the device may comprise a lattice attached to the wall of the cavity or near it and an element applied to the surface of said lattice and extending to the wall of said cavity so as to seal the opening.

In practice, the porous element is obtained from the granulate and binder mixture which is pasty, and which is spread onto the lattice, using a suitable tool, in a continuous layer of more or less significant thickness. In this case, advantageously according to the invention, the element obtained after a few hours is a continuous layer of porous agglomerate with open porosity, of thickness varying between 1 cm and 4 cm. This embodiment has the advantage of a perfect adjustment to irregular shapes of the containers. It allows the ends of gutters to be closed off for example, or to connect two preformed elements, for example when they form an angle between them. It requires little material and is therefore particularly lightweight.

The lattice can be secured to the wall of the cavity, or near and outside it, by various means available to the person skilled in the art who knows how to choose them wisely. Preferably, a lattice is chosen made of a flexible enough material so it can be adapted to the desired shape using a simple hand tool, but rigid enough to support the porous element, including when the latter is waterlogged. In addition, the mesh must be adapted to retain the granulate before solidification of the agglomerate. Thus, according to the invention, said lattice may be a screen made of metal (preferably made of galvanized steel, or stainless steel), plastic or textile fabric, having a mesh size of 3 mm to 8 mm, preferably of 5 mm. It should be noted that the mesh of the lattice may be larger than that of the granulate particles. However, it has been noted that the granulate has a tendency to remain agglomerated even before the material had set.

Regardless of the embodiment chosen, the device according to the invention may incorporate other members, providing related functions. It can notably be equipped with means for holding the porous element in place, such as clips, tabs or retaining hooks to hold it in position in the cavity, etc. Likewise, it may comprise gripping means, such as a handle, hook, ring, etc., which may be secured to the element by various means. They can, for example, be secured to an armature embedded in the agglomerate, the latter also ensuring its function of internal reinforcement and stiffening of the device. External reinforcement means in the form of banding of the element, for example, can also be used. Thus, in all the aforementioned embodiments of the device of the invention, said element can comprise one or more of the following means:
means for holding it in place,
gripping means,
internal reinforcement armature,
external reinforcement means.

Tests have shown that the device according to the embodiments indicated above offers satisfactory and stable long-term permeability owing to the porosity of the granulate, and ensures a desired cohesive amalgam.

As stated previously, the device of the invention is adapted to eliminate a wide variety of potential breeding sites. It may be prefabricated when these breeding sites have a standard or at least known dimension, or even installed on site. The methods of combating this laying of eggs in water tanks are original in themselves. This is why the invention also relates to a method for combating the proliferation of aquatic larvae, mosquitoes or other, in containers likely to hold stagnant water, using one of the devices as described above.

In particular, the invention relates to a method for combating the proliferation of aquatic larvae in containers likely to hold stagnant water, said containers comprising a wall defining a cavity and a large opening, comprising the steps consisting of:
preparing a mixture of a rubber granulate and of a synthetic binder,
pouring said mixture into a mold having the desired shape, completely or partially identical to that of the wall of said cavity, in order to obtain, after removal from the mold, an element made of a material that is permeable to air and to water as described previously, the shape of which completely or partially conforms to that of the wall of said cavity and seals off said opening, and
placing said element in said container.

In an interesting variant, an absorbent fabric is placed in the bottom of the mold before pouring the mixture in order to capture the binder which may accumulate in the bottom of the mold and form an impermeable layer. The element is removed from the mold before the binder has completely set. It is then easy to separate the fabric from the element which is not completely dry. A geotextile fabric, such as those used in civil engineering works to stabilize structures by creating a physical permeable barrier (often referred to as Bidim™), has been proven to possess the required absorbent properties. It is removed by tearing it away with a simple gesture, after the element has partially dried.

For this method, a mold having a shape identical to the most common receiving supports (containers) can be made, such as a portion of gutter for example. This mold is used as a jig in which the device is manufactured in series.

According to an alternative embodiment, the method for combating the proliferation of aquatic larvae in containers likely to hold stagnant water, said containers comprising a wall defining a cavity and a large opening, can comprise the steps consisting of:
preparing a mixture of a rubber granulate and of a synthetic binder,
fastening a lattice to the wall of the cavity or overlapping near it,
applying a continuous layer of said mixture on the lattice up to the wall of said cavity or overlapping near it, to obtain an element made of a material that is permeable to air and to water at the surface of said lattice sealing off the opening of said cavity, as described above.

Both of the above methods allow for the use of an agglomerate made from recycled rubber granulates and polyurethane resin, to form not a plug but a hermetic barrier to insects that is permeable to air and water. In this manner, female insects are permanently prevented from accessing these containers of stagnant water.

The device is very easy to install and requires no special tools other than those usually employed by craftsmen. Once installed, the porous element may be left in place or removed at will for maintenance and replaced. Its lifetime is in line with that of its support.

Series production can be easily accomplished, although it is also very convenient for a craftsman to manufacture the elements needed for a given project. Standard elements can be prepared in advance, and the finishing touches can be performed on site as described above. The material is also lightweight and easily cut using a cutter or handsaw, for example, for optimum fit. To a large extent it uses recycled materials, which can in turn be reused.

The preferential fields of application will be gutters, catch basins, culverts, flower pot saucers, planters, basins, and more generally all outdoor containers that can contain or retain water.

Unexpectedly, another field of application has appeared to be of interest for the device of the present invention. As mentioned above, it acts as a water and air filter, and not a plug. In this manner, it was revealed that it was also useful in reducing foul-smelling pollution, notably from septic tanks, the opening of which is often open to the air. The insertion of a device into this opening, very simple and requiring no masonry work, appeared highly effective in reducing and even totally eliminating unpleasant odors.

The present invention will be better understood from the description of the variants of embodiment in relation to the appended figures, in which:

FIG. 1 is a schematic sectional view of a gutter equipped with a preformed device according to the invention.

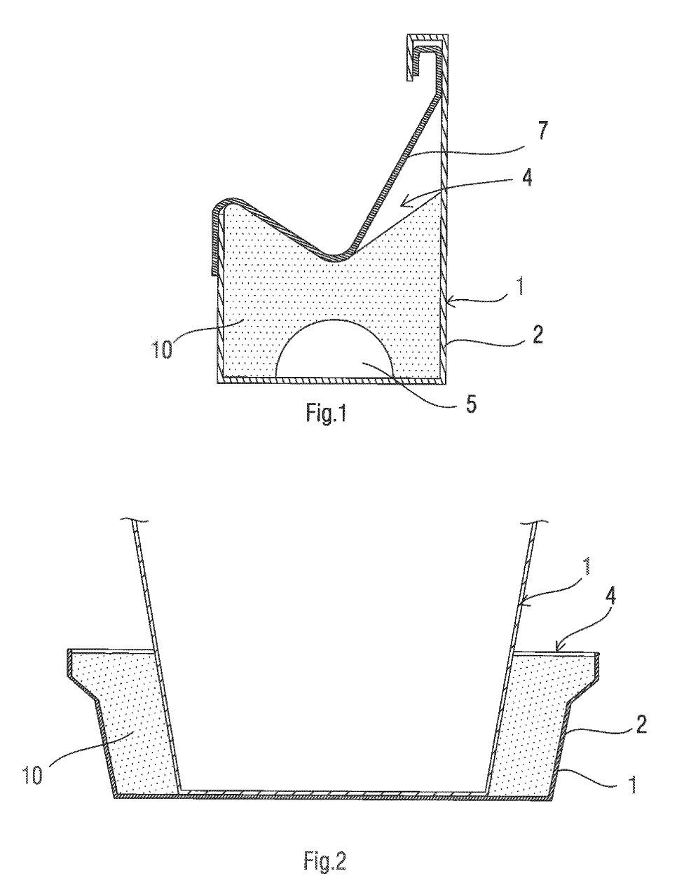

FIG. 2 is a schematic sectional view of a flower pot and its saucer equipped with a preformed device according to the invention.

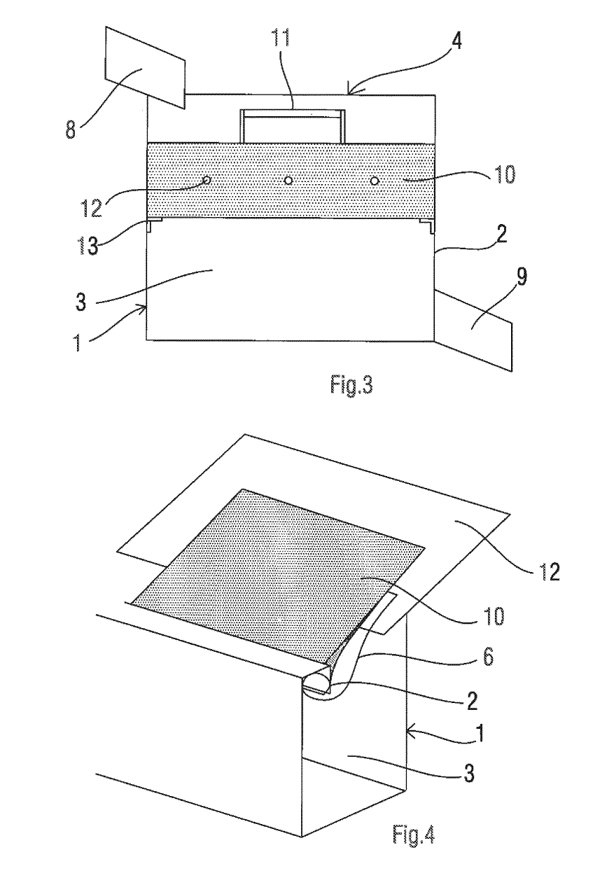

FIG. 3 is a schematic sectional view of a catch basin equipped with a preformed device according to the invention.

FIG. 4 is a schematic perspective view of a gutter equipped with a device made on site according to the invention.

### EXAMPLE 1

### Gutter Equipped with a Preformed Device

FIG. 1 represents a schematic sectional view of a gutter 1 equipped with a preformed device 10. The gutter comprises the side walls 2 and bottom, and the large opening 4. It is occupied by the porous element 10 preformed in the shape of a long block matching the side walls of the gutter. The element comprises the hole 5 extending longitudinally through the lower portion of the block element 10. The water collected from the opening 4, having passed through the element 10, can freely flow to the downspout. The geometry of the element 10 is designed so as to be inserted below the roof's gutter retaining bracket 7. This has the advantage of not requiring the modification of the gutter retaining systems commonly used. The bracket can also play a role in keeping said element 10 in place.

The element consists of an agglomerate composed of a rubber granulate (particles of approximately 5 mm) and a polyurethane binder (comprised of aromatic polyisocyanates, e.g. distributed by the SNAD company under reference STOBIELAST s131.98), with 1 kg of granulate and 150 g of binder. After mixing in a mixer with a vertical axis, the mixture is poured into a gutter, used as a jig, and allowed to harden for approximately 24 hours at ambient temperature (the actual duration can vary depending on the temperature and humidity). The elements thus obtained weigh 3.5 kg per linear meter, which a gutter can easily support if it is properly secured.

### EXAMPLE 2

### Flower Pot and Saucer Equipped with a Preformed Device

FIG. 2 represents a schematic sectional view of a flower pot and its saucer equipped with a preformed device. The space left between the flower pot and the saucer creates a suitable annular container 1 for mosquitoes to lay eggs. There has been placed into this space a preformed annular element 10 adjusted to the size of the flower pot and its saucer. The porous agglomerate was previously molded to the shape of the flower pot and the saucer so as to occupy the entire height of the empty saucer so as not to allow any water to be freely accessible.

The element 10 consists of a rubber granulate (particles of approximately 5 mm) and a polyurethane binder (comprised of aromatic polyisocyanates, e.g. distributed by the SNAD company under reference STOBIELAST S131.98), with 1 kg of granulate and 180 g of binder. After mixing, the mixture is poured into a jig and allowed to harden for approximately 24 hours at ambient temperature. The elements thus obtained have a lower porosity but better resistance, characteristics adapted to their use (no large throughput of water but a risk of crushing of the annular element between the flower pot and its saucer).

### EXAMPLE 3

### Catch Basin Equipped with a Preformed Device

FIG. 3 represents a schematic sectional view of a catch basin equipped with a preformed device. The catch basin is a concrete tank with a rectangular cross section, which receives water from the upper supply pipe 8, and provided with a discharge outlet 9 near its base. The element 10 is a block of the same rectangular cross section as the tank that it equips. It rests on the angle brackets 13, at approximately mid-height, so that the water is collected in the upper portion, is filtered through the element 10 and flows into the lower part toward the discharge outlet 9. The handle facilitates insertion and removal of the device. It is subject to the metal reinforcement elements 12 (concrete rebar type) reinforcing the rubber agglomerate.

This device helps prevent leaves and other vegetal matter from cluttering the catch basins and gutters. It prevents debris from entering the catch basin (and gutters) and it also prevents pests (rats, cockroaches, centipedes, etc.) from exiting.

Generally speaking, this type of device makes catch basins and gutters more accessible and facilitates cleaning. Its thickness also contributes to reducing foul odors.

The element 10 is comprised of a rubber granulate (particles of approximately 5 mm) and a polyurethane binder (for example the STOBIELAST S131.98 product from SNAD), with 1 kg of granulate and 120 g binder. After mixing, the mixture is poured into a jig, the armatures and the handle are placed, and the assembly is allowed to harden for approximately 24 hours at ambient temperature. The elements thus obtained have a high porosity with average strength, and characteristics adapted for their purpose (large throughput of water but little risk of damage to the element protected by the tank).

### EXAMPLE 4

### Gutter Equipped with a Device Made on Site

When it is not possible to produce the invention by prior fabrication (due to gutters or roofs with special shapes), or by the customers choice, an alternative on site variant is possible: a lightweight screen type armature completes the system. FIG. 4 represents a schematic perspective view of a gutter equipped with a device produced on site. The device comprises the lattice 6 secured to the wall 2 of the gutter 3 and near it at the base of the roof 12, and the element 10 applied to the surface of the lattice 6 and extending to the wall 2 of the gutter 3 so as to seal off the opening.

The element 10 is comprised of a rubber granulate (particles of approximately 5 mm) and a polyurethane binder (for example the STOBIELAST S131.98 product from SNAD), with 1 kg of granulate and 150 g binder. After mixing in a vertical mixer, the mixture is applied with a trowel onto the screen previously secured to the gutter, and compressed into a layer of 1 to 4 cm thick. The elements thus obtained weigh substantially less than a preformed block.

This device allows the gutter to be made integral with the roof, also preventing leaves and plant matter from cluttering the pipes and gutters. It is no longer necessary to perform delicate and frequent maintenance.

1-13. (canceled)

14. A device for combating the proliferation of aquatic larvae in containers likely to hold stagnant water, said containers comprising a wall defining a cavity and a large opening, said device comprising an element, the shape of which is designed to completely or partially conform to that of the wall of said cavity and to seal off said opening, said element being produced from a porous material permeable to air and to water, comprising a rubber granulate and a synthetic binder.

15. The device as claimed in claim 14, wherein said material is an agglomerate with open porosity comprised of rubber particles bound by a polyurethane resin.

16. The device as claimed in claim 14, wherein the binder is a polyurethane resin dosed at a ratio of 5% to 20% by weight, relative to the rubber granulate.

17. The device as claimed in claim 14, wherein the granulate is comprised of rubber particles ranging in size from 1 mm to 20 mm.

18. The device as claimed in claim 14, wherein said element is preformed in a shape designed to completely conform to that of the wall of the cavity, so as to entirely seal the container.

19. The device as claimed in claim 14, wherein the element is preformed in a shape designed to partially conform to that of the wall of the cavity, at least one through hole being provided in the lower portion of said element so as to promote the circulation of the collected water after it has passed through said element.

20. The device as claimed in claim 14, wherein the element is preformed in a shape designed to partially conform to that of the wall of the cavity and able to cooperate with support means equipping the wall of said cavity so as to create a space at the bottom of the container for collecting the water after it has passed through said element.

21. The device as claimed in claim 14, comprising a lattice adapted to be fastened to the wall of the cavity or near said wall and an element applied to the surface of said lattice and extending to the wall of said cavity so as to seal off the opening.

22. The device as claimed in claim 21, wherein the element is a continuous layer of porous agglomerate with open porosity, of thickness varying between 1 cm and 4 cm.

23. The device as claimed in claim 21, wherein the lattice is a screen made of metal or plastic material having a mesh size of 3 mm to 8 mm.

24. The device as claimed in claim 14, wherein the element further comprises means for holding it in place.

25. The device as claimed in claim 14, wherein the element further comprises gripping means.

26. The device as claimed in claim 14, wherein the element further comprises an internal reinforcement armature.

27. The device as claimed in claim 14, wherein the element further comprises external reinforcement means.

28. A method for combating the proliferation of aquatic larvae in containers likely to hold stagnant water, said containers having a wall defining a cavity and a large opening, said method comprising the steps consisting of:
preparing a mixture of a rubber granulate and of a synthetic binder,
pouring said mixture into a mold having the desired shape, completely or partially identical to that of the wall of said cavity, in order to obtain, after removal from the mold, an element made of a material that is permeable to air and to water according to claim 14, the shape of which completely or partially conforms to that of the wall of said cavity and seals off said opening, and
placing said element in said container.

29. A method for combating the proliferation of aquatic larvae in containers likely to hold stagnant water, said containers having a wall defining a cavity and a large opening, said method comprising the steps consisting of:
preparing a mixture of a rubber granulate and of a synthetic binder,
fastening a lattice to the wall of the cavity or overlapping near it,
applying a continuous layer of said mixture on the lattice up to the wall of said cavity or overlapping near it, to obtain an element made of a material that is permeable to air and to water at the surface of said lattice sealing off the opening of said cavity, according to claim 14.

30. The device as claimed in claim 15, wherein the binder is a polyurethane resin dosed at a ratio of 5% to 20% by weight, relative to the rubber granulate.

31. The device as claimed in claim 22, wherein the lattice is a screen made of metal or plastic material having a mesh size of 3 mm to 8 mm.

32. A method for combating the proliferation of aquatic larvae in containers likely to hold stagnant water, said containers having a wall defining a cavity and a large opening, said method comprising the steps consisting of:
preparing a mixture of a rubber granulate and of a synthetic binder,
pouring said mixture into a mold having the desired shape, completely or partially identical to that of the wall of said cavity, in order to obtain, after removal from the mold, an element made of a material that is permeable to air and to water according to claim 24, the shape of which completely or partially conforms to that of the wall of said cavity and seals off said opening, and
placing said element in said container.

33. A method for combating the proliferation of aquatic larvae in containers likely to hold stagnant water, said containers having a wall defining a cavity and a large opening, said method comprising the steps consisting of:
preparing a mixture of a rubber granulate and of a synthetic binder,
fastening a lattice to the wall of the cavity or overlapping near it,
applying a continuous layer of said mixture on the lattice up to the wall of said cavity or overlapping near it, to obtain an element made of a material that is permeable to air and to water at the surface of said lattice sealing off the opening of said cavity, according to claim 21.
